(19) United States
(12) Patent Application Publication
(10) Pub. No.: US 2022/0234417 A1
(43) Pub. Date: Jul. 28, 2022

(54) AIR CONDITIONING UNIT

(71) Applicant: DENSO CORPORATION, Kariya-city (JP)

(72) Inventor: Satoshi KUSANAGI, Kariya-city (JP)

(21) Appl. No.: 17/722,539

(22) Filed: Apr. 18, 2022

Related U.S. Application Data
(63) Continuation of application No. PCT/JP2020/036354, filed on Sep. 25, 2020.

(30) Foreign Application Priority Data
Oct. 30, 2019 (JP) 2019-197868

(51) Int. Cl. B60H 1/00

(52) U.S. Cl. CPC B60H 1/00521; B60H 2001/00121; B60H 2001/00635

(57) ABSTRACT

An air conditioning unit includes: an air conditioning case having a passage through which air flows from an air inlet into a cabin; a first heat exchanger disposed in the passage of the air conditioning case so as to adjust a temperature of the air flowing through the passage; a second heat exchanger disposed in the passage of the air conditioning case and located downstream of the first heat exchanger in a flow of air; and a closure portion provided on at least one of the first heat exchanger and the second heat exchanger so as to close a gap between the first heat exchanger and the second heat exchanger.

### CROSS REFERENCE TO RELATED APPLICATION

The present application is a continuation application of International Patent Application No. PCT/JP2020/036354 filed on Sep. 25, 2020, which designated the U.S. and claims the benefit of priority from Japanese Patent Application No. 2019-197868 filed on Oct. 30, 2019. The entire disclosures of all of the above applications are incorporated herein by reference.

### TECHNICAL FIELD

The present disclosure relates to an air conditioning unit.

### BACKGROUND

An air conditioning unit having two heat exchangers housed in one frame can be attached to and detached from an air conditioning case.

### SUMMARY

According to an aspect of the present disclosure, an air conditioning unit includes: an air conditioning case having a passage through which air flows from an air inlet into a cabin; a first heat exchanger disposed in the passage of the air conditioning case so as to adjust a temperature of the air flowing through the passage; a second heat exchanger disposed in the passage of the air conditioning case and located downstream of the first heat exchanger in a flow of air; and a closure portion provided on at least one of the first heat exchanger and the second heat exchanger so as to close a gap between the first heat exchanger and the second heat exchanger.

### BRIEF DESCRIPTION OF DRAWINGS

FIG. 1 is a cross-sectional view of an air conditioning unit according to a first embodiment.

FIG. 2 is a perspective view of a second heat exchanger viewed from an upstream side in an air flow.

FIG. 3 is a perspective view of the second heat exchanger viewed from a downstream side in the air flow.

FIG. 4 is a front view of the second heat exchanger as viewed from a downstream side in the air flow.

FIG. 5 is a cross-sectional view taken along a line V-V of FIG. 4.

FIG. 6 is an external view illustrating a side surface of the air conditioning case in a state where a first heat exchanger and a second heat exchanger are not assembled to the air conditioning case.

FIG. 7 is an external view illustrating the side surface of the air conditioning case in a state where the first heat exchanger and the second heat exchanger are assembled to the air conditioning case.

FIG. 8 is an enlarged view of an area VIII of FIG. 7.

FIG. 9 is a cross-sectional view taken along a line IX-IX of FIG. 8.

FIG. 10 is an external view illustrating a side surface of an air conditioning case, in an air conditioning unit of a comparative example, in a state where a first heat exchanger and a second heat exchanger are not assembled to the air conditioning case.

FIG. 11 is a cross-sectional view of the air conditioning unit of the comparative example at a location corresponding to FIG. 9.

FIG. 12 is a front view of a second heat exchanger in an air conditioning unit according to a second embodiment.

FIG. 13 is a cross-sectional view taken along a line XIII-XIII of FIG. 12.

### DESCRIPTION OF EMBODIMENTS

To begin with, examples of relevant techniques will be described.

An air conditioning unit conditions air in a cabin. The air conditioning unit has two heat exchangers for heating air flowing through a passage in an air conditioning case. The heat exchangers are housed in one frame and can be attached to and detached from the air conditioning case.

The air conditioning unit mounted on the vehicle is required to be downsized due to some restrictions relative to the vehicle. In contrast to such a demand, since the air conditioning unit needs a frame body for housing the two heat exchangers, the physique of the air conditioning unit becomes large. Further, the number of components increases.

In order to reduce the size of the body, it is conceivable to arrange the two heat exchangers close to each other. However, in that case, a partition wall provided between the two heat exchangers in the frame becomes thin. There is a concern that the partition wall may have insufficient rigidity or molding failure, and air leakage may occur.

In order to restrict the partition wall from becoming thin, it is conceivable to set a direction in which one of the two heat exchangers is inserted into the frame and a direction in which the other heat exchange is inserted into the frame opposite to each other. However, in that case, since the manufacturing process becomes complicated and the cycle time becomes long, the manufacturing cost increases. In such a case, it is difficult to reduce the size of the air conditioning unit.

The present disclosure provides an air conditioning unit which can be downsized in the body.

According to one aspect of the present disclosure, an air conditioning unit configured to condition air in a cabin, the air conditioning unit includes: an air conditioning case having a passage through which air flows from an air inlet into the cabin, the air conditioning case having one opening; a first heat exchanger disposed in the passage of the air conditioning case through the one opening so as to adjust a temperature of the air flowing through the passage; a second heat exchanger disposed in the passage of the air conditioning case through the one opening and located downstream of the first heat exchanger in a flow of air; and a closure portion provided on at least one of the first heat exchanger and the second heat exchanger so as to close a gap between the first heat exchanger and the second heat exchanger.

Accordingly, it is possible to eliminate the frame and the partition wall between the first heat exchanger and the second heat exchanger. Therefore, the number of parts can be reduced, and the partition wall between the first heat exchanger and the second heat exchanger can have sufficient rigidity or be free from molding failure. The first heat exchanger and the second heat exchanger can be placed close to each other in the air conditioning unit, due to the closure portion provided on at least one of the first heat exchanger and the second heat exchanger to close the gap between the first heat exchanger and the second heat exchanger. Therefore, the air conditioning unit can be downsized.

A reference numeral attached to each component or the like indicates an example of correspondence between the component or the like and specific component or the like described in embodiments below.

Embodiments of the present disclosure will now be described with reference to the drawings. Parts that are identical or equivalent to each other in the following embodiments are assigned the same reference numerals and will not be described.

### First Embodiment

A first embodiment will be described with reference to the drawings. The air conditioning unit 1 of the present embodiment is arranged inside an instrument panel of a vehicle (not shown). The air conditioning unit 1 sucks in one or both of inside air in the cabin and outside air outside the cabin, and blows out conditioned air having adjusted temperature and humidity into the cabin so as to condition air in the cabin.

The overall configuration of the air conditioning unit 1 of the present embodiment will be described.

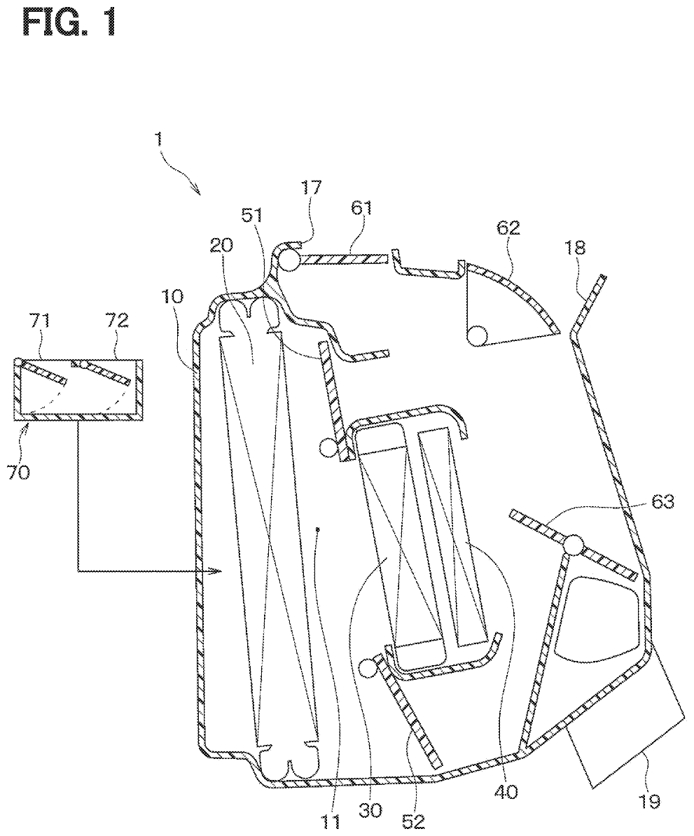

As shown in FIG. 1, the air conditioning unit 1 includes an air conditioning case 10, an evaporator 20, a heater core 30 as a first heat exchanger, a positive temperature coefficient (PTC) heater 40 as a second heat exchanger, air mix doors 51 and 52, and mode doors 61, 62, 63.

The air conditioning case 10 is made of a resin such as polypropylene having a certain degree of elasticity and excellent strength. The air conditioning case 10 has a passage 11 inside the outer wall, and air flows through the passage 11.

Air is introduced from the blower unit 70 into the passage 11 upstream of the evaporator 20. The blower unit 70 is configured to take in inside air or outside air from the air inlet 71, 72 by driving a blower (not shown), and to flow the air to the upstream area of the evaporator 20 in the passage 11 in the air conditioning case 10. The air conditioning case 10 has plural outlet openings 17, 18, 19 for blowing out air flowing through the passage 11 into the cabin. The outlet openings 17, 18, 19 are arranged on the downstream side of each heat exchanger. Therefore, the air introduced from the air inlet 71, 72 of the blower unit 70 flows through the passage 11 in the air conditioning case 10 and is supplied to the cabin from the outlet opening 17, 18, 19.

The outlet openings 17, 18 and 19 are a defroster outlet opening 17, a face outlet opening 18, and a foot outlet opening 19. The defroster outlet opening 17 blows out air toward the windshield of the vehicle. The face outlet opening 18 blows out air toward the upper body of the occupant seated on the front seat. The foot outlet opening 19 blows out air toward the feet of the occupant seated on the front seat. A duct (not shown) is attached to each of the outlet openings 17, 18, and 19. The duct is connected to each outlet provided in a predetermined place in the cabin.

The evaporator 20 is a refrigerant heat exchanger for cooling the air flowing through the passage 11 in the air conditioning case 10. The evaporator 20 constitutes a well-known refrigeration cycle together with a compressor, a condenser, an expansion valve, and the like (not shown). The evaporator 20 is arranged downstream of the expansion valve and upstream of the compressor in the refrigeration cycle. A refrigerant that has been decompressed by the expansion valve into gas-liquid two-layer state flows inside a tube (not shown) of the evaporator 20. The evaporator 20 cools the air by heat exchange between the refrigerant flowing inside the tube and the air passing outside the tube. The first heat exchanger adjusts the temperature of the air flowing through the passage 11 in the air conditioning case 10. Specifically, the heater core 30 as the first heat exchanger is a hot water heat exchanger for heating the air flowing through the passage 11 in the air conditioning case 10. The heater core 30 is provided downstream of the evaporator 20 in the air flow in the passage 11 in the air conditioning case 10. A heat medium such as engine cooling water flows inside a tube (not shown) of the heater core 30. The heater core 30 heats the air by exchanging heat between the heat medium flowing inside the tube and the air passing outside the tube.

The second heat exchanger is provided downstream of the first heat exchanger in the air flow. Specifically, the PTC heater 40 as the second heat exchanger and the heater core 30 as the first heat exchanger are arranged substantially in parallel and close to each other. The PTC heater 40 is an electric heat exchanger for heating the air flowing through the passage 11 in the air conditioning case 10. The PTC heater 40 energizes an electric resistor to generate heat. The PTC heater 40 heats the air by heat exchange between the heat radiating fin including the electric resistor and the air passing between the heat radiating fins. The specific configuration of the PTC heater 40 will be described later.

The air mix doors 51, 52 and the mode doors 61, 62, 63 are arranged in the passage 11 of the air conditioning case 10.

The air mix doors 51, 52 are two sliding doors provided between the evaporator 20 and the heater core 30. In FIG. 1, the air mix doors 51, 52 are arranged so that all of the air that has passed through the evaporator 20 flows through the heater core 30. It is possible to allow a part or all of the air that has passed through the evaporator 20 to bypass the heater core 30 by changing the positions of the air mix doors 51, 52. The positions of the air mix doors 51, 52 are switched according to the selected air conditioning mode.

The mode doors 61, 62, 63 are a defroster door 61, a face door 62, and a foot door 63. The defroster door 61 adjusts the amount of air blown from the defroster outlet opening 17. The face door 62 adjusts the amount of air blown from the face outlet opening 18. The foot door 63 adjusts the amount of air blown from the foot outlet opening 19. The positions of the mode doors 61, 62, 63 are also switched according to the selected air conditioning mode.

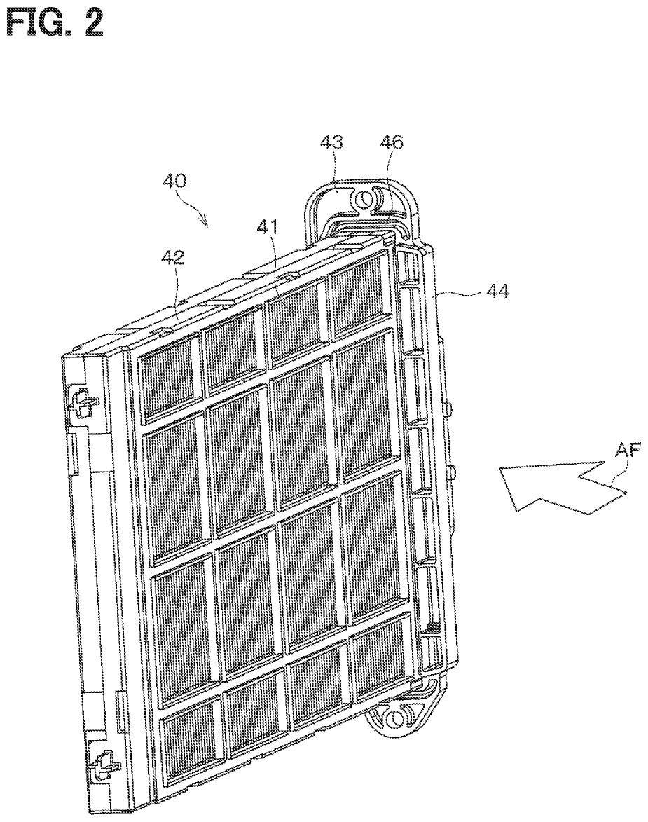

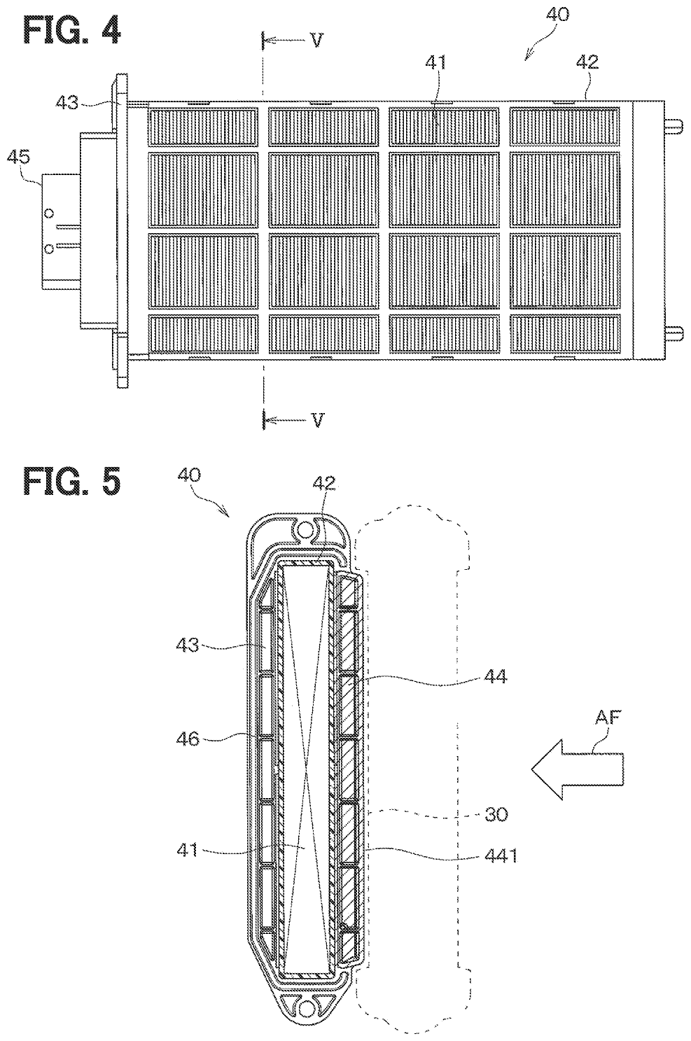

Next, the configuration of the PTC heater 40 will be described with reference to FIGS. 2 to 5. The arrows AF in FIGS. 2, 3 and 5 indicate the air flow direction when the PTC heater 40 is installed in the air conditioning case 10. As shown in FIGS. 2 to 5, the PTC heater 40 has a heat radiating fin 41, a frame 42, a flange 43, and a closure portion 44. The heat radiating fin 41 includes an electric resistor that generates heat when energized. The heat radiating fins 41 are arranged in parallel at predetermined intervals. When the air passes between the heat radiating fins 41, the air is heated. The frame 42 constitutes the outer frame of the heat radiating fin 41. The frame 42 is made of a resin (such as PA66/GF) having excellent heat resistance, rigidity, dimensional stability, and the like. The flange 43 is provided at one end of the frame 42. The flange 43 is made of a resin having the same characteristics as the frame 42. As shown in FIG. 4, the flange 43 has a connector 45 for energizing the electric resistor.

As shown in FIGS. 2 and 5, the closure portion 44 is provided at a side of the PTC heater 40 opposing the heater core 30. The closure portion 44 is provided so as to extend from the PTC heater 40 toward the heater core 30. As shown in FIG. 5, the outer edge 441 of the closure portion 44 adjacent to the heater core 30 has a shape along the outer edge of the heater core 30. In FIG. 5, for convenience of explanation, the closure portion 44 is hatched, although it is not a cross section, in order to show the closure portion 44 in an easy-to-understand manner. Further, in FIG. 5, the position of the outer edge of the heater core 30 is shown by a broken line. As shown in FIG. 5, the closure portion 44 is configured to close the gap between the PTC heater 40 and the heater core 30.

The closure portion 44 is made of a resin having the same characteristics as the frame 42 and the flange 43. The closure portion 44, the frame 42, and the flange 43 are integrally formed of resin. A side of the closure portion 44 opposite to the heater core 30 is connected to the frame 42 and the flange 43. Therefore, the closure portion 44 has a highly rigid structure.

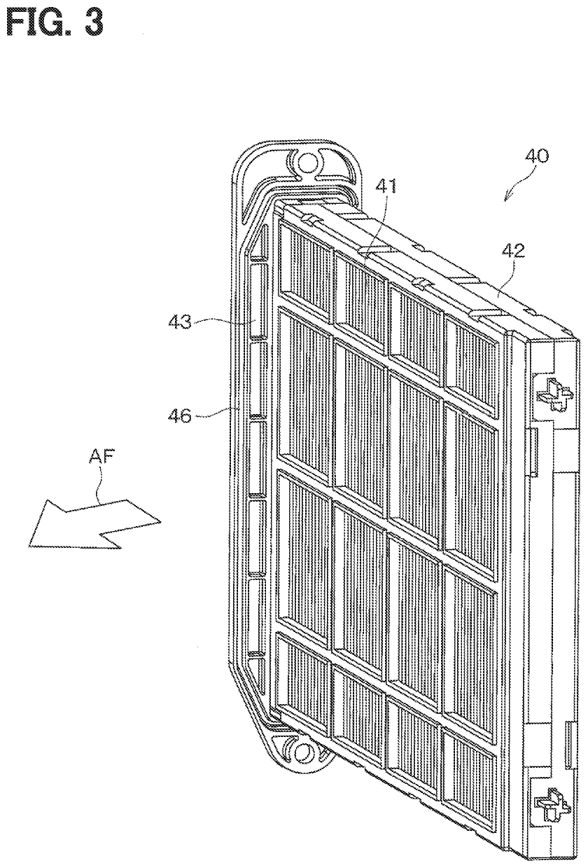

As shown in FIGS. 3 and 5, the flange 43 of the PTC heater 40 has a fitting groove 46. Specifically, the fitting groove 46 is continuously provided in a portion of the flange 43 opposite to the heater core 30, an upper portion and a lower portion in FIG. 5 (that is, a portion excluding the closure portion 44). The fitting groove 46 fits into a rib provided around the opening of the air conditioning case 10 described later.

A method of assembling the heater core 30 and the PTC heater 40 to the air conditioning case 10 will be described.

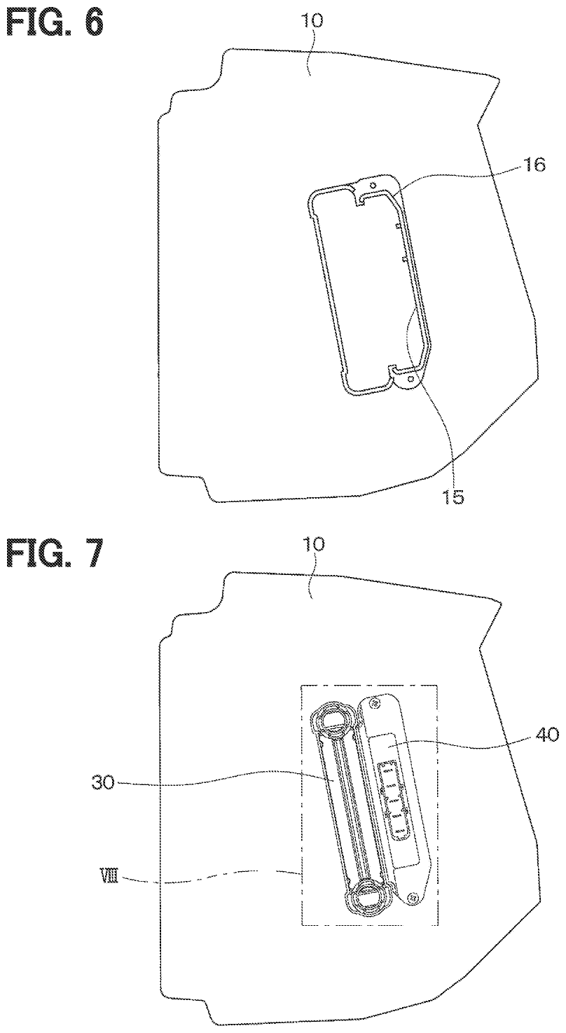

FIG. 6 is an external view of the side surface of the air conditioning case 10 in a state where the heater core 30 and the PTC heater 40 are not assembled to the air conditioning case 10. The side surface of the air conditioning case 10 has one opening 15 for attaching/detaching the heater core 30 and the PTC heater 40. The air conditioning case 10 has the rib 16 that fits into the fitting groove 46 provided in the flange 43 of the PTC heater 40, and the rib 16 is provided adjacent to the opening 15.

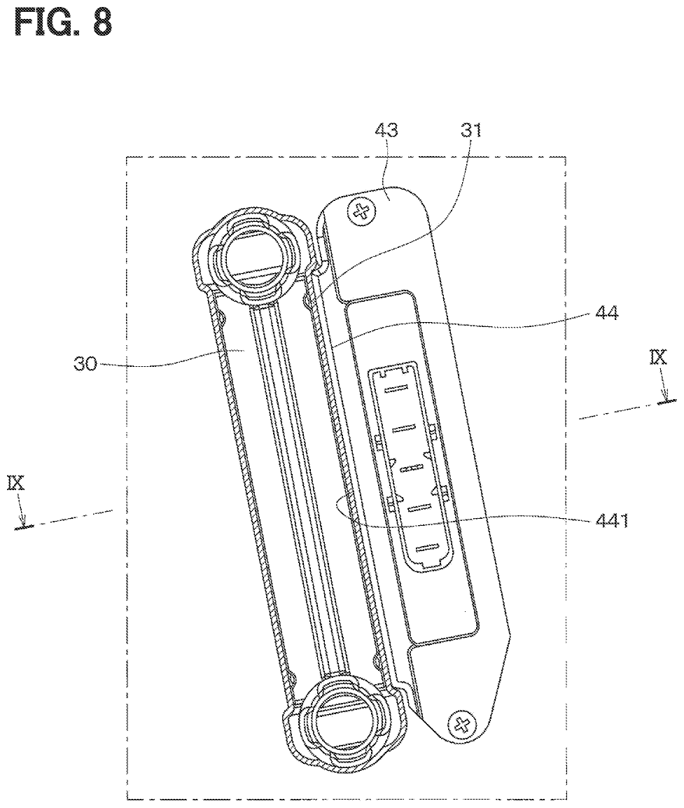

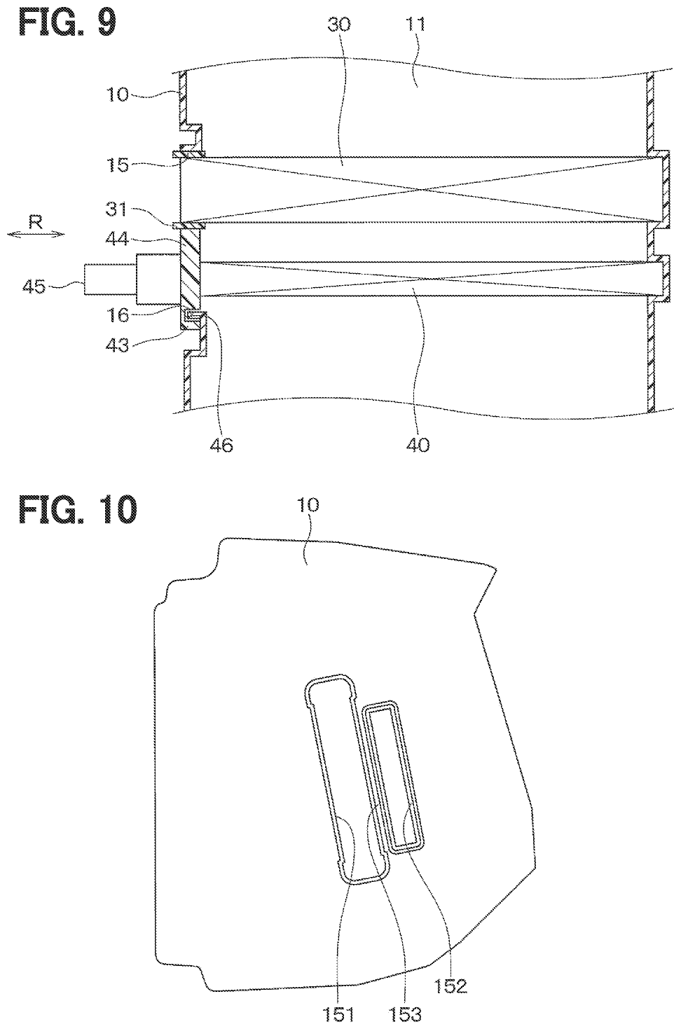

FIGS. 7 and 8 are external views of the side surface of the air conditioning case 10 in which the heater core 30 and the PTC heater 40 are assembled to the air conditioning case 10. FIG. 9 is a cross-sectional view taken along a line IX-IX of FIG. 8. The heater core 30 and the PTC heater 40 are installed inside the air conditioning case 10 through the one opening 15 provided on the side surface of the air conditioning case 10. Therefore, the heater core 30 and the PTC heater 40 can be attached to and detached from the same direction with respect to the air conditioning case 10. In FIG. 9, the arrow R represents the direction in which the heater core 30 and the PTC heater 40 are attached to and detached from the air conditioning case 10. Both the heater core 30 and the PTC heater 40 are directly fitted into the opening 15 of the air conditioning case 10. The gap between the heater core 30 and the PTC heater 40 is closed by the closure portion 44 provided in the PTC heater 40.

The flange 43 of the PTC heater 40 is provided so as to cover the outer side of the opening 15 of the air conditioning case 10. The fitting groove 46 provided on the surface of the flange 43 adjacent to the air conditioning case 10 is fitted to the rib 16 provided around the opening 15 of the air conditioning case 10.

A seal packing 31 is provided at a portion of the heater core 30 that fits into the inner wall surface of the opening 15 of the air conditioning case 10. The seal packing 31 can be formed of a material having a low elastic modulus such as porous urethane or rubber. The seal packing 31 is provided so as to surround the end portion of the heater core 30. In FIG. 8, for convenience of explanation, the seal packing 31 is hatched, although it is not a cross section, in order to show the seal packing 31 in an easy-to-understand manner. The seal packing 31 is provided in a compressed state between the heater core 30 and the inner wall surface of the opening 15 of the air conditioning case 10, and between the heater core 30 and the closure portion 44. As a result, the seal packing 31 provided on the heater core 30 comes into close contact with the inner wall surface of the opening 15 of the air conditioning case 10 and the closure portion 44, so as to restrict air leakage from the passage 11 in the air conditioning case 10 to the outside.

It is possible to abolish the seal packing 31 so that the inner wall surface of the opening 15 of the air conditioning case 10 and the outer edge of the heater core 30 come into contact with each other. Even in such a configuration, it is possible to reduce air leakage by improving the dimensional accuracy of each configuration. That is, the heater core 30 and the PTC heater 40 of the present embodiment are configured to be directly fitted to the opening 15 of the air conditioning case 10, without using a rigid body such as frame body in a comparison example. The configuration of direct fitting in the present specification means fitting without using a rigid body such as frame body in the comparison example. The configuration of direct fitting in the present specification includes both of a fitting via a seal packing 31 and a configuration in which the seal packing 31 is not interposed.

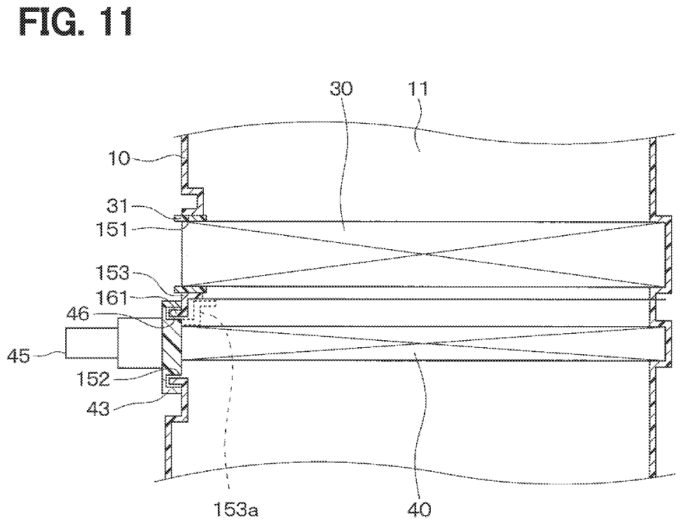

In order to compare with the air conditioning unit 1 of the first embodiment, an air conditioning unit of the comparative example will be described with reference to FIGS. 10 and 11. Even in the air conditioning unit of the comparative example, it is assumed that the heater core 30 and the PTC heater 40 are arranged close to each other.

FIG. 10 is an external view of the side surface of the air conditioning case 10 of the comparative example in a state where the heater core 30 and the PTC heater 40 are not assembled to the air conditioning case 10. The side surface of the air conditioning case 10 of the comparative example has a first opening 151 for attaching/detaching the heater core 30 and a second opening 152 for attaching/detaching the PTC heater 40. A partition wall 153 that separates the first opening 151 and the second opening 152 is provided between the first opening 151 and the second opening 152. The partition wall 153 constitutes a part of the air conditioning case 10.

FIG. 11 is a cross-sectional view of a state in which the heater core 30 and the PTC heater 40 are assembled to the air conditioning case 10 of the comparative example, and corresponds to FIG. 9 referred to in the description of the first embodiment. The heater core 30 is fitted to the inner wall surface of the first opening 151. The PTC heater 40 is fitted to the inner wall surface of the second opening 152. The space between the heater core 30 and the PTC heater 40 is closed by the partition wall 153 of the air conditioning case 10.

In the comparative example, the flange 43 of the PTC heater 40 is provided so as to cover the outer side of the second opening 152 of the air conditioning case 10. In the comparative example, the fitting groove 46 is provided over both the side of the flange 43 adjacent to the heater core 30 and the side of the flange 43 away from the heater core 30. The fitting groove 46 fits to the rib 161 provided around the second opening 152 of the air conditioning case 10.

In the air conditioning unit of the comparative example, the partition wall 153 provided between the first opening 151 and the second opening 152 is thin. Therefore, it is conceivable that the partition wall 153 has insufficient rigidity or molding failure. In that case, when the PTC heater 40 is assembled to the air conditioning case 10, the rib 161 provided on the partition wall 153 and the fitting groove 46 of the flange 43 of the PTC heater 40 may be misaligned from each other. At this time, as shown by the broken line 153a in FIG. 11, the partition wall 153 shifts from the normal position. In that case, air leaks from the passage 11 in the air conditioning case 10 to the outside. Therefore, in the configuration of the air conditioning unit of the comparative example, it is difficult to arrange the heater core 30 and the PTC heater 40 close to each other because there is a concern that the partition wall 153 has insufficient rigidity or molding defects.

The air conditioning unit 1 of the first embodiment has the following effects compared with the air conditioning unit of the comparative example.

(1) In the first embodiment, the heater core 30 and the PTC heater 40 are installed inside the air conditioning case 10 through the one opening 15 provided in the air conditioning case 10. The gap between the heater core 30 and the PTC heater 40 is closed by the closure portion 44 provided so as to extend from the PTC heater 40 toward the heater core 30.

This makes it possible to eliminate the partition wall 153 between the first opening 151 and the second opening 152 in the air conditioning unit of the comparative example. According to the first embodiment, since the connection area where the PTC heater 40 and the closure portion 44 are connected is large, it is possible to restrict the closure portion 44 from becoming insufficiently rigid or molding poorly. Therefore, in the air conditioning unit 1, the rigidity of the closure portion 44 provided in the PTC heater 40 is increased and the moldability is improved. Further, the heater core 30 and the PTC heater 40 are arranged close to each other to downsize the air conditioning unit 1.

(2) In the first embodiment, the outer edge 441 of the closure portion 44 adjacent to the heater core 30 has a shape along the outer edge of the heater core 30.

As a result, the seal packing 31 provided on the heater core 30 can be brought into close contact with the closure portion 44. Therefore, the air conditioning unit 1 can surely restrict air leakage from the gap between the heater core 30 and the closure portion 44.

(3) In the first embodiment, the frame 42 and the closure portion 44 are integrally formed.

As a result, the rigidity of the closure portion 44 can be increased, and the manufacturing cost can be reduced.

(4) In the first embodiment, the air conditioning unit 1 includes the seal packing 31 provided on the heater core 30. The seal packing 31 is in close contact with the inner wall surface of the opening 15 of the air conditioning case 10 and the closure portion 44.

As a result, the air conditioning unit 1 can restrict air leakage by filling the gap between the heater core 30 and the closure portion 44 with the seal packing 31.

(5) In the first embodiment, the flange 43 of the PTC heater 40 has the fitting groove 46. The fitting groove 46 is configured to fit with the rib 16 provided adjacent to the opening 15 of the air conditioning case 10.

As a result, the air conditioning unit 1 can restrict air leakage from a portion of the flange 43 opposite to the closure portion 44.

(6) In the first embodiment, the heater core 30 and the PTC heater 40 are removable in the same direction with respect to the air conditioning case 10. The heater core 30 and the PTC heater 40 are directly fitted to the opening 15 of the air conditioning case 10.

Accordingly, it is possible to improve the assembling property of the heater core 30 and the PTC heater 40 with respect to the air conditioning case 10. Therefore, the cycle time at the time of manufacturing can be shortened, and the manufacturing cost can be reduced. Further, since the air conditioning unit 1 of the first embodiment does not have the frame body of the comparison example, the increase in the number of parts is restricted and the air conditioning unit 1 can be downsized.

### Second Embodiment

A second embodiment will be described below. The second embodiment is a modification of the first embodiment in which the second heat exchanger is modified, and the other parts are the same as those of the first embodiment. Therefore, only the parts different from the first embodiment will be described.

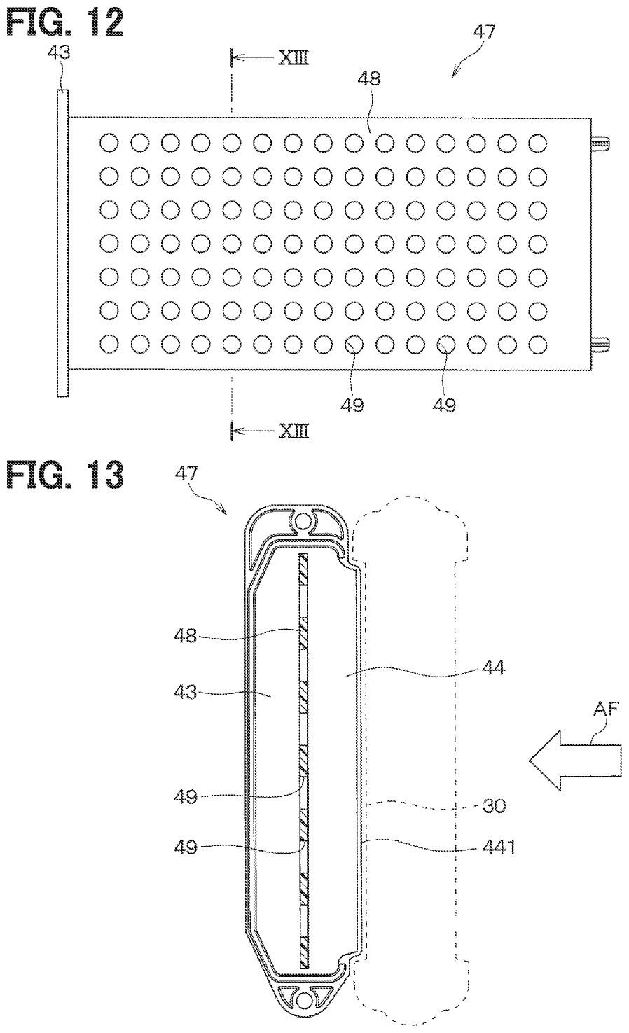

As the second heat exchanger, the air conditioning unit 1 of the second embodiment has a dummy heat exchanger 47 as shown in FIGS. 12 and 13, in place of the PTC heater 40 in the first embodiment. The dummy heat exchanger 47 does not have a heat exchange function and is composed of a member having a predetermined air resistance.

Specifically, the dummy heat exchanger 47 has a plate member 48, a flange 43, and a closure portion 44. The plate member 48 has plural holes 49 through which air can pass. The ventilation resistance of the plate member 48 is set to be substantially the same as that of the PTC heater 40 in the first embodiment. The flange 43 is provided at one end of the plate member 48. The closure portion 44 provided in the dummy heat exchanger 47 is also configured to close the gap between the dummy heat exchanger 47 and the heater core 30 as in the first embodiment.

Similar to the first embodiment, in the air conditioning unit 1 of the second embodiment, the rigidity and the moldability of the closure portion 44 provided in the dummy heat exchanger 47 as the second heat exchanger are improved, and the heater core 30 and the dummy heat exchanger 47 can be arranged close to each other. Therefore, the air conditioning unit 1 can be downsized. In addition, the second embodiment can also exert the same action and effect as the first embodiment.

### Other Embodiments

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the above embodiments, when the shapes, positional relationships, and the like of the components and the like are referred to, the shapes, positional relationships, and the like are not limited thereto unless otherwise specified or limited to specific shapes, positional relationships, and the like in principle.

(1) In each of the embodiments, a general air conditioning unit for a cabin is described, but is not limited to this. The air conditioning unit 1 may be configured to have an inside/outside air two-layer mode in which the inside air introduced from the inside air inlet and the outside air introduced from the outside air inlet are separately supplied to the cabin.

(2) In each of the embodiments, the heater core 30 is exemplified as the first heat exchanger, but is not limited to this. The first heat exchanger is, for example, a heat medium type heat exchanger in which a heat medium other than engine cooling water flows, or a refrigerant type heat exchanger such as condenser or evaporator for a refrigerating cycle.

(3) The PTC heater 40 and the dummy heat exchanger 47 are exemplified as the second heat exchanger, but not limited to this. The second heat exchanger may be an electric heat exchanger other than the PTC heater 40, a heat medium heat exchanger through which engine cooling water or other heat medium flows, or a refrigerant heat exchanger such as condenser for a refrigeration cycle.

(4) In each of the embodiments, the closure portion 44 that closes the gap between the first heat exchanger and the second heat exchanger is provided in the second heat exchanger, but not limited to this. The closure portion 44 may be provided in the first heat exchanger, or may be provided in both the first heat exchanger and the second heat exchanger.

According to the first aspect shown in part or all of the embodiments, an air conditioning unit for a cabin includes an air conditioning case, a first heat exchanger, a second heat exchanger, and a closure portion. The air conditioning case has a passage for air introduced from an air inlet to flow into the cabin. The first heat exchanger is installed in the passage of the air conditioning case through one opening provided in the air conditioning case, and regulates the temperature of the air flowing through the passage. The second heat exchanger is installed inside the air conditioning case from the same opening as the first heat exchanger, and is provided on the downstream side of the first heat exchanger in a flow of air. The closure portion is provided on at least one of the first heat exchanger and the second heat exchanger, and is configured to close the gap between the first heat exchanger and the second heat exchanger.

According to the second aspect, the outer edge of the closure portion is shaped along the outer edge of the other of the first heat exchanger and the second heat exchanger.

Accordingly, the air conditioning unit can restrict air leakage from the location between the other of the first heat exchanger and the second heat exchanger and the closure portion.

According to the third aspect, the second heat exchanger is any one of an electric heat exchanger, a refrigerant heat exchanger, a heat medium heat exchanger, or a dummy heat exchanger. The closure portion is integrally formed with the frame or plate member of the second heat exchanger.

Accordingly, it is possible to increase the rigidity of the closure portion and reduce the manufacturing cost by integrally forming the frame or plate member of the second heat exchanger and the closure portion.

According to the fourth aspect, the air conditioning unit further includes a seal packing provided between the other of the first heat exchanger and the second heat exchanger and the closure portion.

Accordingly, the air conditioning unit can restrict air leakage by filling the gap between the other of the first heat exchanger and the second heat exchanger and the closure portion with the seal packing.

According to the fifth aspect, the second heat exchanger has a flange that closes the opening of the air conditioning case. The flange has a fitting groove that fits with a rib provided around the opening of the air conditioning case.

Accordingly, the air conditioning unit can restrict air leakage from a portion of the flange opposite to the closure portion.

According to the sixth aspect, the first heat exchanger and the second heat exchanger are attachable to and removable from the air conditioning case in the same direction, and are directly fitted to the opening of the air conditioning case.

Accordingly, it is possible to improve the assembling property of the first heat exchanger and the second heat exchanger with respect to the air conditioning case. Therefore, the cycle time at the time of manufacturing can be shortened, and the manufacturing cost can be reduced. Further, according to the configuration of the sixth aspect, since the air conditioning unit does not have a frame body, the increase in the number of parts is prevented and the air conditioning unit can be downsized.

What is claimed is:

1. An air conditioning unit configured to condition air for a cabin, the air conditioning unit comprising:
an air conditioning case having a passage through which air flows from an air inlet into the cabin, the air conditioning case having one opening;
a first heat exchanger disposed in the passage of the air conditioning case through the one opening so as to adjust a temperature of the air flowing through the passage;
a second heat exchanger disposed in the passage of the air conditioning case through the one opening and located downstream of the first heat exchanger in a flow of air; and
a closure portion provided on at least one of the first heat exchanger and the second heat exchanger so as to close a gap between the first heat exchanger and the second heat exchanger.

2. The air conditioning unit according to claim 1, wherein an outer edge of the closure portion has a shape along an outer edge of the other of the first heat exchanger and the second heat exchanger.

3. The air conditioning unit according to claim 1, wherein
the second heat exchanger is one of an electric heat exchanger, a refrigerant heat exchanger, a heat medium heat exchanger, or a dummy heat exchanger, and
the closure portion is integrally formed with a frame or a plate member of the second heat exchanger.

4. The air conditioning unit according to claim 1, further comprising a seal packing provided between the other of the first heat exchanger and the second heat exchanger and the closure portion.

5. The air conditioning unit according to claim 1, wherein
the second heat exchanger has a flange that closes the one opening of the air conditioning case, and
the flange has a fitting groove that fits with a rib provided adjacent to the opening of the air conditioning case.

6. The air conditioning unit according to claim 1, wherein the first heat exchanger and the second heat exchanger are attachable to and detachable from the air conditioning case in a same direction and are directly fitted to the one opening of the air conditioning case.
